(19) United States
(12) Patent Application Publication
(10) Pub. No.: US 2022/0379506 A1
(43) Pub. Date: Dec. 1, 2022

(54) HAIR-CUTTING APPARATUS

(71) Applicant: KONINKLIJKE PHILIPS N.V., EINDHOVEN (NL)

(72) Inventors: Theodoor René Maria HIN, EMMEN (NL); Luca IACCARINO, GRONINGEN (NL); Everhardus Johannes HOEXUM, GRONINGEN (NL)

(21) Appl. No.: 17/627,958

(22) PCT Filed: Jul. 28, 2020
(86) PCT No.: PCT/EP2020/071321

§ 371 Date: Jan. 18, 2022

(30) Foreign Application Priority Data
Jul. 30, 2019 (EP) 19189104.3

(51) Int. Cl. B26B 19/48; B26B 19/44; B26B 19/38

(52) U.S. Cl. CPC B26B 19/48; B26B 19/44; B26B 19/3853

(57) ABSTRACT

In order to improve hair debris collection, it is proposed to position a cut-hair-blocking element 18 with a partitioned barrier/shield 28 in front of a cutting arrangement 12 of a hair-cutting apparatus 10. Examples of the partitioned barrier/shield include e.g. a rigid comb shield 28a with spacings between teeth, a rigid comb barrier 28b with flexible material between teeth, and a fully flexible barrier. The partitioned barrier/shield allows hair to be cut to enter a cutting zone 20, but prevents cut hair from flying off.

### FIELD OF THE INVENTION

The present invention relates to a hair-cutting apparatus.

### BACKGROUND OF THE INVENTION

Hair clippers employing vacuum to collect cut hair parts during clipping are known for quite a while already. One of the design challenges is to optimize hair debris collection, thus minimizing the amount of cut hair parts spreading into the grooming environment. For example, WO 2004/002691 A1 describes a hair-cutting apparatus with means for preventing cut hair from flying off. The means has a boundary wall extending close to the cutting arrangement. The boundary wall has a stationary portion and a portion that is movable relative to the stationary portion. The movable portion is arranged and positioned to cooperate with the hair to be cut. Further, U.S. Pat. No. 9,381,655 B2 discloses a double-blade hair trimming device having a trimmer handle and a blade head, the blade head having a blade unit for cutting long hair and a blade unit for short hair. The fixed blade of the long hair cutter has teeth adjacent to teeth of a blade had protective cover.

### SUMMARY OF THE INVENTION

There may be a need to improve hair debris collection.

The object of the present invention is solved by the subject-matter of the independent claims, wherein further embodiments are incorporated in the dependent claims. It should be noted that the following described aspects of the invention apply also for the hair-cutting apparatus.

A first aspect of the present invention provides a hair-cutting apparatus. A hair-cutting apparatus comprises:

a cutting arrangement (12) for cutting hair; and

a cut-hair-blocking element (18) arranged in front of a cutting zone (20) of the cutting arrangement in a direction in which the hair-cutting apparatus is moved to cut hairs during use, and sufficiently close to an upper side (22) of the cutting arrangement for counter-acting flying off cut hair (60) from the hair-cutting apparatus, wherein the upper side is opposite to a skin-touching side (24) of the cutting arrangement;

wherein the cut-hair-blocking element has a hair receiving portion (26) at a bottom of the cut-hair-blocking element close to the cutting zone for allowing hair to be cut to pass through the hair receiving portion to enter the cutting zone;

wherein the hair receiving portion has a row of cut-hair-blocking members (28, 28a, 28b), wherein adjacent cut-hair-blocking members have an interspace (29) therebetween that is sufficiently small to prevent the cut hair from passing through the interspace, or wherein adjacent cut-hair-blocking members have no interspace therebetween;

wherein the cut-hair-blocking members comprise barrier members (28b);

wherein the barrier members (28b) are sufficiently flexible such that the barrier members (28b) undergo sufficiently large deformation under a force caused by the hair to be cut for allowing the hair to be cut to pass through the barrier members (28b) to enter the cutting zone; and

wherein the barrier members (28b) are sufficiently stiff such that the barrier members (28b) undergo no or little deformation under a force caused by the cut hair for preventing the cut hair from flying off; and

wherein the cut-hair-blocking members are contiguous to a tip of a guard blade of the cutting arrangement.

According to an embodiment of the present invention, the cut-hair-blocking members comprise both barrier members and shield members, wherein the shield members are sufficiently stiff such that the shield members undergo no or little deformation under a force caused by the hair to be cut and under a force caused by the cut hair for preventing the cut hair from flying off; wherein the interspace between adjacent shield members is sufficiently large to allow the hair to be cut to pass through the interspace to enter the cutting zone; and wherein the barrier members are arranged within the interspace between adjacent shield members. In such an embodiment a better barrier function is realized within the interspace between adjacent shield members.

In other words, in first aspect of the invention it is proposed to use the bottom portion of a cut-hair-blocking element to provide two functions: a) receiving uncut hair: allowing hair to be cut, i.e. hair on skin, to pass through the bottom portion to enter a cutting zone, and b) blocking cut hair: preventing cut hair from passing through the bottom portion of the cut-hair blocking element. That is to say, the bottom portion of the cut-hair-blocking element defines a hair receiving portion. In order to allow hair to be cut to pass through the hair receiving portion, it is proposed to partition the bottom portion of the cut-hair-blocking element, i.e. the hair receiving portion, thereby creating one or more rows of cut-hair-blocking members. The one or more rows of cut-hair-blocking members may have any number of cut-hair-blocking members. According to an exemplary embodiment, the number of the cut-hair-blocking members may be 2, 3, 4, 5, 6, 7, 8, 9, 10, 15, 20, 30, 40, 60, 80, 100, 200, 300 or the number may be even higher.

Two types of cut-hair-blocking members are proposed, shield members and barrier members. The shield members are also referred to as rigid members, which are stiffer than the hair to be cut and function as walls blocking the hair to be cut. Hair stiffness may vary between body parts and between individuals. For a detailed discussion concerning the mechanical properties of hair, reference is made to the following publication: George T. Rado and Harry Suhl M. Benzarti, M. B. Tkaya, C. P. Mattei, and H. Zahouani, Hair mechanical properties depending on age and origin, Word Academy of Science, Engineering and Technology, International Journal of Biotechnology and Bioengineering, Vol. 5, No. 2, 2011. This publication states that the statistical axial stiffness of the hair varies between 1000 N/m and 1600 N/m. The shield members may be configured to be resistant against bending deformation under a force caused by the hair to be cut. That is, the shield member may be configured to have a sufficiently high bending stiffness such that the shield members undergo no or little bending deformation under a force caused by the hair to be cut. The bending stiffness of the shield members is a function based upon two essential properties: the elastic modulus (stress per unit strain) of the material that composes it, and the moment of inertia, a function of the cross-sectional geometry. The bending stiffness of the shield members is also dependent on the length of the shield members. Therefore, by carefully selecting the material, the cross-sectional geometry, and the length of the shield members, the shield members can be configured to undergo no or little bending deformation under a force caused by the hair to be cut during cutting. For example, the shield members may be made of rigid plastic or metal.

The barrier members may also be referred to as flexible members, which are less stiff than the hair to be cut. In other words, the barrier members may be configured to have a sufficiently low bending stiffness such that the barrier members undergo sufficiently large bending deformation under a force caused by the hair to be cut. In this way, the barrier members may form entrance points for allowing the hair to be cut to enter the cutting zone. The bending stiffness of the barrier members is also a function based upon the elastic modulus (stress per unit strain) of the material that composes it, the moment of inertia, and a length of the barrier members. Therefore, by carefully selecting the material, the cross-sectional geometry, and the length of the barrier members, the barrier members can be configured to undergo relatively large deformation under a force caused by the hair to be cut during cutting. According to an exemplary embodiment, the material stiffness of the barrier members may be in a range between 0 and 1800 N/m, such as 100 N/m, 200 N/m, 300 N/m, 400 N/m, 500 N/m, 600 N/m, 700 N/m, 800 N/m, 1000 N/m, 1100 N/m, 1200 N/m, 1300 N/m, 1400 N/m, 1500 N/m, 1600 N/m, 1700 N/m, and 1800 N/m.

The shield members and the barrier members have at least one characteristic in common—they function as a “wall” to prevent cut hair from passing through the shield members and the barrier members, but differ in the functionality with respect to the hair to be cut. As will be explained hereafter and particularly with respect to FIGS. 2A and 4, the shield members also function as a wall against the hair to be cut—that is, the hair to be cut cannot pass through the shield members to enter the cutting zone, but rather through the interspace between adjacent shield members. As will be explained hereafter and particularly with respect to FIGS. 2B, 5A, and 5B, unlike the shield members, the barrier members are flexible enough so as to be deformed under the force caused by the hair to be cut, thereby forming one or more openings to allow hair to be cut to enter the cutting zone. In other words, the barrier members themselves can function as entrance points for the hair to be cut. Therefore, in some examples, the barrier members may be provided as extra entrances in addition to the interspace between adjacent barrier members. An exemplary implementation of this option, i.e. barrier members with interspaces therebetween, is illustrated in the example (i) of FIG. 2B. In some other examples, the barrier members may be provided as the sole entrance points for the hair to be cut. In other words, no interspace exists between adjacent barrier members. An exemplary implementation of this option, i.e. barrier members with no interspace therebetween, is illustrated in the example (ii) of FIG. 2B.

With the shield members and the barrier members, there are several possibilities to realize the above-mentioned functions.

The first option is that the bottom portion of the cut-hair-blocking element has the shield members only. This options is not part of the present invention. The shield members may be arranged in a comb-like structure, and therefore the shield members represent teeth. As the shield members are rigid, they are stiffer than the hair to be cut and undergo no or little deformation under a force caused by the hair to be cut. Thus, the interspace between adjacent shield members functions as an entrance point to let the hair to be cut to enter the cutting zone. Therefore, the interspace between adjacent shield members should be sufficiently large to allow the hair to be cut to pass through the interspace. However, as the cut hair may also fly out from the same interspace. The interspace has to be sufficiently small to prevent cut hair from passing through the interspace. The diameter of the hair may vary between 50 μm to 220 μm at different anatomical positions. The size, geometry, and/or pattern of the interspaces may be optimized to improve the efficiency of receiving hair to be cut to enter the cutting zone on the one hand, and the efficiency of preventing cut hair from passing through the interspace on the other hand. According to an exemplary embodiment, the interspace may have a width in a range between 0.1 mm and 2 mm, such as 0.2 mm, 0.3 mm, 0.4 mm, 0.5 mm, 0.6 mm, 0.7 mm, 0.8 mm, 1 mm, 1.2 mm, 1.3 mm, 1.4 mm, 1.5 mm, 1.6 mm, 1.7 mm, 1.8 mm, 1.9 mm, and 2 mm. An exemplary implementation of the shield members is illustrated in FIG. 4. In this illustrated example, the shield members and the guard blade have aligned teeth slots. This may facilitate receiving uncut hair.

The second option is that the bottom portion of the cut-hair-blocking element has the barrier members only. This option is part of the present invention. Unlike the shield members, the barrier members are flexible, i.e. less stiff than the hair to be cut. Thus, the hair to be cut can pass undisturbed through the barrier members, as the flexible barrier members undergo sufficiently large deformation under a force caused by the hair to be cut. In other words, the working principle of the barrier members is different from that of the shield members. Therefore, unlike shield members, a sufficiently large interspace between adjacent barrier members is not required for receiving the hair to be cut. The same barrier function of the barrier members should also prevent the hair debris from passing through the barrier members. The barrier members make use of the difference in properties of hair before and after it is cut. In other words, the barrier members are less stiff than the hair to be cut, but sufficiently stiff to such that the barrier members undergo no or little deformation under a force caused by the cut hair for preventing the cut hair from flying off, i.e. impact speed and mass of hair debris, i.e. cut hair, is too low to pass through the barrier. The difference in properties of hair before and after it is cut thus defines a working window of optimally functioning barrier members. The barrier members may be arranged in a brush-like structure and thus barrier members represent bristles. Alternatively or additionally, the barrier members may be arranged in a strip-curtain-like structure, each barrier member representing a segment flap element. In other words, the barrier members can function as entrance points for allowing hair to be cut to enter the cutting zone. Therefore, it is not required to provide interspaces between adjacent barrier members to allow hair to be cut to enter the cutting zone. The barrier members alone can function as an opening under the force caused by the hair to be cut. This will be explained particularly with respect to the exemplary embodiment in the example (ii) of FIG. 2B. Of course, it is also possible to provide interspaces between adjacent barrier members. In this way, both the barrier members and the interspaces may function as entrance points for allowing the hair to be cut to enter the cutting zone. This will be explained in detail particularly with respect to the exemplary embodiment in the example (i) of FIG. 2B. The flexibility, size, geometry, and/or pattern of the barrier members may be configured to improve the efficiency of receiving hair to be cut to enter the cutting zone on the one hand, and the efficiency of preventing cut hair from passing through the barrier members on the other hand.

The third option is that the cut-hair-blocking members have both the shield members and barrier members. This option is part of the present invention. In this case, the barrier members may be arranged within the interspace between adjacent shield members. In other words, the barrier members provide a barrier function within the interspace between adjacent shield members.

As the bottom portion of the cut-hair-blocking element itself functions as hair receiving portion, the cut-hair-blocking element may be arranged in front of the cutting zone of the cutting arrangement, and sufficiently close to an upper side of the cutting arrangement for counter acting flying off cut hair. In fact, the bottom portion of the cut-hair-blocking element may be contiguous to a tip of the guard blade. On the one hand, as the interspace between adjacent shield members and/or barrier members is sufficiently small, hair debris are prevented from passing through the cut-hair-blocking element. On the other hand, the bottom portion of the cut-hair-blocking element does not disturb or prevent uncut hair entering the cutting zone, as the interspace between adjacent shield members and/or the flexibility of the barrier members will allow the hair to be cut to enter the cutting zone.

Using the proposed hair-cutting apparatus has at least one of the following advantages:
The cut-hair-blocking element may be used in a vacuum beard trimmer, but also can be applied in a non-vacuum hair removal appliance to reduce the hair scatter.
The cut-hair-blocking element may be used in a conventional hair-cutting apparatus with an attachable comb to set a haircut length, or in a cutting arrangement without an attachable comb.
The cut-hair-blocking element with shield members and/or barrier members blocks hair from escaping from the hair-cutting apparatus, thus enabling a higher hair pick up by the airflow. As the bottom portion of the cut-hair-blocking element itself has the function of allowing hair to be cut to enter the cutting zone, the cut-hair-blocking element may be arranged contiguous to a tip of the guard blade. This may further improve the restriction for the hair debris to escape from the airflow, while allowing the uncut hair to enter the cutting without disturbance of especially orientation of the hair.
The interspace between adjacent shield members allows for a smaller air inlet. The small air inlet and optimized flow path may lead to, based on the same vacuum force, increasing airflow speed in the area where the hair cutting takes place. This may increase catching efficiency of the vacuum system.
As the cut hairs bounce against the cut-hair-blocking element, their velocity is drastically reduced to levels that are not exceeding that of the vacuum suction airflow and can therefore be easily sucked into the hair container.
A series of detachable cut-hair-blocking elements may be provided for forming a hair-cutting apparatus kit. The geometry of each cut-hair-blocking element may be tuned in order to tune for both the airflow increase and initial hair length entrance to the cutter blade.

The cut-hair-blocking members are contiguous to a tip of a guard blade of the cutting arrangement. Such an arrangement will not disturb the cutting operation of the hair-cutting apparatus, since the flexible barrier members and the interspace between adjacent shield members allow uncut hair to enter the cutting zone.

According to an embodiment of the present invention, the hair-cutting apparatus further comprises a vacuum nozzle for transporting cut hair to a hair chamber. The cut-hair-blocking element is arranged and positioned for reducing an opening area between the vacuum nozzle and the cutting arrangement.

For example, the cut-hair-blocking element may be arranged between the vacuum nozzle and the cutting arrangement. The reduction of the opening area may lead to, based on the same vacuum force, increasing airflow speed in the area where the hair cutting takes place. This arrangement that cut-hair-blocking members are contiguous to a tip of a guard blade of the cutting arrangement. may further improve the hair catching efficiency of the vacuum system.

According to an embodiment of the present invention, the shield members are provided in form of a comb-like structure.

This will be explained hereafter and particularly with respect to the exemplary embodiment in FIG. 2A.

According to an embodiment of the present invention, the barrier members are provided in form of a brush-like structure and/or a strip-curtain-like structure.

This will be explained hereafter and particularly with respect to the exemplary embodiments in FIG. 2B.

According to an embodiment of the present invention, the cut-hair-blocking element has a boundary wall for counter-acting the flying off cut hair from the hair-cutting apparatus.

As the hairs bounce against the boundary wall, their velocity is drastically reduced to levels that are not exceeding that of the vacuum suction airflow and can therefore be easily sucked into the hair container.

According to an embodiment of the present invention, the shield members have a pitch that matches a pitch of the guard blade.

In other words, the shield members and the guard blade have aligned teeth slots. This may facilitate receiving uncut hair.

According to an embodiment of the present invention, the cut-hair-blocking element is retractable such that the cut-hair-blocking element is positionable in an extended position and a retracted position. In the extended position, the cut-hair-blocking element is positioned sufficiently close to the upper side of the cutting arrangement for counter-acting flying off cut hair from the hair-cutting apparatus. In the retracted position, the cut-hair-blocking element is distanced further away from the upper side of the cutting arrangement as compared to the extended position. In other words, in the retracted position, the cut-hair-blocking element has a larger distance from the upper side of the cutting arrangement as compared to the extended position.

For example, if the hair-cutting apparatus is a vacuum assisted clipper, when the cut-hair-blocking element is in the extended position, the cut-hair-blocking element may be arranged and positioned for reducing an opening area between the vacuum nozzle and the guard blade. When the cut-hair-blocking element is in the retracted position, the cut-hair-blocking element may be arranged and positioned for unblocking the opening area. An advantage of having a retractable cut-hair-blocking element may be seen in that in the retracted position, it may be easier to clean hair debris on the surface of the cutting arrangement, as the cut-hair-blocking element is positioned sufficiently away from the upper side of the cutting arrangement.

According to an embodiment of the present invention, the cut-hair-blocking element is an element integrated with the hair-cutting apparatus.

According to an embodiment of the present invention, the cut-hair-blocking element is a detachable element.

In other words, the cut-hair-blocking element may be removed and separated from the hair-cutting apparatus. An advantage of having a detachable element may be seen in that one cut-hair-blocking element may be replaced by another cut-hair-blocking element e.g. for setting a different initial hair length entrance.

According to an embodiment of the present invention, the hair-cutting apparatus comprises a series of detachable cut-hair-blocking elements. The series of detachable cut-hair-blocking elements comprises at least a first detachable cut-hair-blocking element and a second detachable cut-hair-blocking element. The first detachable cut-hair-blocking element has a hair receiving portion that allows hair to be cut with a first length to pass through hair receiving portion to enter a cutting zone. The second detachable cut-hair-blocking element has a hair receiving portion that allows hair to be cut with a second length to pass through hair receiving portion to enter the cutting zone. The first length is different from the second length.

According to an embodiment of the present invention, the shield members are configured such that the interspace between adjacent shield members has a geometry that is adapted to a desired haircut length including at least one of the first length and the second length.

According to an embodiment of the present invention, the barrier members are configured to have a height that is adapted to a desired haircut length including at least one of the first length and the second length.

As used herein, the expression “shield members are sufficiently stiff”, or “barrier members are sufficiently flexible/stiff” refers to the extent of the resistance of the shield members and barrier members against bending deformation when subjected to a force caused by hair to be cut and/or cut hair when the hair-cutting apparatus is moved to cut hairs during use.

As used herein, the term “sufficiently” refers to the complete or nearly complete extent or degree of a state as indicated. For example, a reference that the shield members are sufficiently stiff such that the shield members undergo no or little deformation under a force caused by the cut hair would mean that the shield members are sufficiently stiff to carry out a particular function, i.e. preventing the cut hair from flying off. The exact allowable degree of deviation from absolute completeness may depend on the desired barrier function.

These and other aspects of the present invention will become apparent from and be elucidated with reference to the embodiments described hereinafter.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 schematically shows a hair-cutting apparatus according to some embodiments of the present disclosure.

FIGS. 2A to 2C schematically illustrate three examples of cut-hair-blocking elements.

FIG. 3A shows an example of a vacuum assisted clipper.

FIG. 3B shows another example of a vacuum assisted clipper.

FIG. 4 shows an enlarged view of a cut-hair-blocking element with the shield members.

FIGS. 5A and 5B illustrate an example of a cut-hair-blocking element with the barrier members.

FIG. 6 shows a hair-cutting apparatus kit according to some embodiments of the present disclosure.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF THE EMBODIMENTS

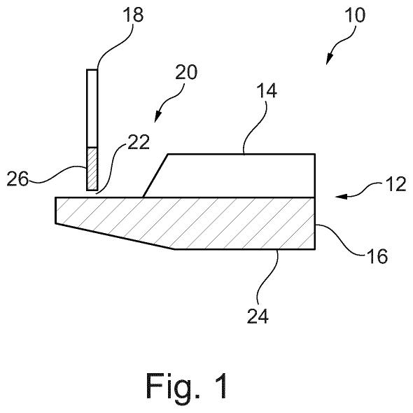

FIG. 1 schematically shows a hair-cutting apparatus 10. The hair-cutting apparatus 10 comprises a cutting arrangement 12 for cutting hair. The cutting arrangement 12 may have a cutter blade 14 for cutting hair and a guard blade 16. The hair-cutting apparatus further comprises a cut-hair-blocking element 18 arranged in front of a cutting zone 20 of the cutting arrangement 12 in a direction in which the hair-cutting apparatus is moved to cut hairs during use, and sufficiently close to an upper side 22 of the cutting arrangement 12 for counter-acting flying off cut hair from the hair-cutting apparatus 10. The upper side 22 is opposite to a skin-touching side 24 of the cutting arrangement 12.

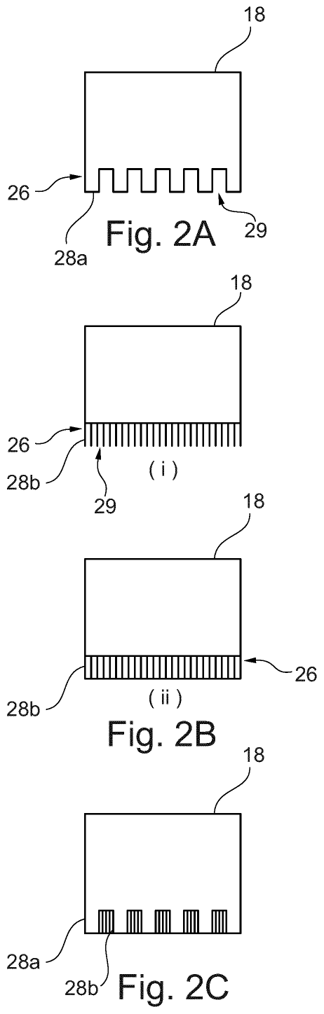

The cut-hair-blocking element 18 has a hair receiving portion 26 at a bottom of the cut-hair-blocking element close to the cutting zone 20 for allowing hair to be cut to pass through the hair receiving portion to enter the cutting zone 20. The hair receiving portion 26 has a row of cut-hair-blocking members 28. The number of the cut-hair-blocking members may be, for example, 2, 3, 4, 5, 6, 7, 8, 9, 10, 15, 20, 30, 40, 60, 80, 100, or even more. Adjacent cut-hair-blocking members 28 may have an interspace 29 therebetween that is sufficiently small to prevent cut hair from passing through the interspace, which will be explained hereafter and particularly with respect to the exemplary embodiments in FIGS. 2A, 2B(i) and 4. Alternatively, adjacent cut-hair-blocking members 28 may have no interspace therebetween, which will be explained hereafter and particularly with respect to the exemplary embodiments in FIGS. 2B(ii) and 2C.

FIGS. 2A to 2C schematically illustrate three examples of cut-hair-blocking element 18.

In the first example, as illustrated in FIG. 2A, the cut-hair-blocking element 18 comprises a plurality of shield members 28a. As explained in the summary of the invention portion, this option is part of the present invention. The shield members 28a are sufficiently stiff such that the shield members 28a undergo no or little deformation under a force caused by the hair to be cut and under a force caused by the cut hair for preventing the cut hair from flying off. For example, the shield members 28a may be made of a hard rigid plastic, which will block the hair to be cut as well as the cut hair from passing through the shield members. In the example of FIG. 2A, the shield members have a comb-like structure. Each shield member represents a tooth. In order to allow the hair to be cut to enter into the cutting zone 20, the interspace between the adjacent shield members 28a is sufficiently large. It is also noted that the interspace between the adjacent shield members 28a has also to be sufficiently small to prevent cut hair from passing through the interspace. Therefore, the selection of the size and geometry of the interspace may be a trade-off between the efficiency of receiving hair to be cut and the efficiency of counter-acting flying off cut hair from the hair-cutting apparatus. For illustration purposes only, six shield members 28a are illustrated in FIG. 2A. A skilled person will appreciate that other number of the shield members 28a may be used, such as 2, 3, 4, 5, 6, 7, 8, 9, 10, 15, 20, 30, 40, 60, 80, 100, or even more. This also applies to the exemplary embodiments in FIGS. 2B and 2C.

In the second example, as illustrated in FIG. 2B, the cut-hair-blocking element comprises barrier members 28b. This option is part of the present invention. On the one hand, the barrier members 28b are sufficiently flexible such that the barrier members 28b undergo sufficiently large deformation under a force caused by the hair to be cut for allowing the hair to be cut to pass through the barrier members to enter the cutting zone 20. On the other hand, the barrier members 28b are sufficiently stiff such that the barrier members undergo no or little deformation under a force caused by the cut hair for preventing the cut hair from flying off. For example, the barrier members 28b may be made of a flexible plastic. The barrier members 28b make use of the difference in properties of hair before and after it is cut, which defines a working window for the barrier members. In the example (i) of FIG. 2B, the barrier members 28b have a brush-like structure. In other words, each barrier member 28b represents a bristle of the brush-like structure. In this illustrated example, interspaces 29 are provided between adjacent barrier members 28b. The interspaces 29 may provide one or more extra entrance points for the hair to be cut in addition to the barrier members 28. In another example (ii), the barrier members 28b have a strip-curtain-like structure. In other words, each barrier member represents a segment flap element. In this illustrated example, no interspaces are provided between adjacent barrier members 28b, since it is a plurality of barrier members 28b that provides entrance points for the hair to be cut. Comparing to the shield members, the barrier members work differently for receiving uncut hair. The barrier function of the barrier members 28b allows hair on skin to pass undisturbed through the barrier members 28b, as the barrier members 28b deform under a force caused by the hair on skin, thereby forming one or more openings under the force caused by the hair on skin. The one or more openings thus allow the hair to be cut to enter the cutting zone. In other words, the whole hair receiving portion 26 may allow hair on skin to enter the cutting zone 20. On the other hand, in the example of FIG. 2A, only the interspace 29 between adjacent shield members receives hair to be cut.

In the third example, as illustrated in FIG. 2C, the barrier members 28b and the shield members 28a may be combined. This option is part of the present invention. In particular, the barrier members 28b, such as bristles or segment flap elements, may be arranged in the interspace between adjacent shield members 28a. In order to allow hair on skin to enter the cutting zone, the interspace should be sufficiently large. The example in FIG. 2C may be more advantageous over the example in FIG. 2A. As previously discussed, the selection of the size and geometry of the interspace in FIG. 2A may be a trade-off between the efficiency of receiving hair to be cut and the efficiency of counter-acting flying off cut hair from the hair-cutting apparatus. This is because the interspace in FIG. 2A is an opening through which cut hair may fly out. However, in the example of FIG. 2C, the additional barrier members 28b inside the interspace, i.e. the opening, has a barrier function that prevents cut hair from flying out. Thus, the interspace may be any size suitable for receiving hair on skin to enter the cutting zone 20.

The hair-cutting apparatus 10 may be a vacuum assisted clipper. In the following, the use of different types of cut-hair-blocking elements 18 in a vacuum assisted clipper have been discussed. The hair-cutting apparatus 10 has a vacuum nozzle 32 for transporting cut hair to a hair chamber (not shown). It is also noted, as previously mentioned, that the cut-hair-blocking element can also be applied in a non-vacuum hair removal appliance to reduce the hair scatter.

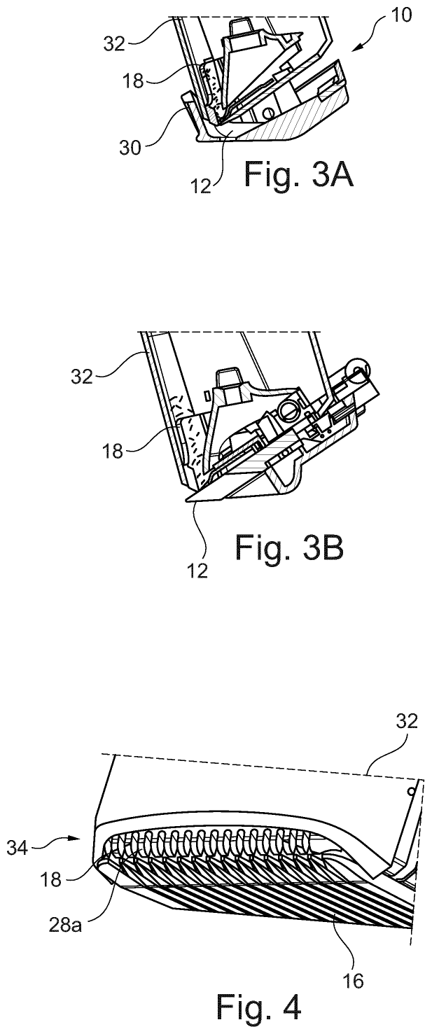

FIG. 3A illustrates a first example of a vacuum assisted clipper. The vacuum assisted clipper are equipped with conventional cutter blades in combination with a front connected adjustable comb 30 to set the hair cut length. Appliances equipped with an adjustable comb 30 reduce hair spray during cutting because the comb teeth act as barriers/shields reducing the hair spray out of the appliance and onto the trimming environment. However, the comb 30 is not able to fully eliminate hair spray out of the comb due to the relatively large comb teeth spacing. Therefore, adding the cut-hair-blocking element 18 as a primary hair spray shield between the cutting arrangement 12 and the vacuum nozzle 32 may further reduce the hair spray out of the system and therefore increase catching efficiency of the vacuum system.

FIG. 3B illustrates a second example of a vacuum assisted clipper. In the illustrated example, there is no front connected adjustable comb and therefore no hair spray reduction feature during trimming. Therefore, the same cut-hair-blocking element 18 may be used as a solution to reduce the hair spray during cutting with a cutter blade. In both implementations in FIGS. 3A and 3B, cut hairs shooting away from the cutting arrangement are blocked by the cut-hair-blocking element 18, which therefore prevents them from falling on the surrounding environment. Additionally, as the hairs bounce against the cut-hair-blocking element 18, their velocity is drastically reduced to levels that are not exceeding that of the vacuum suction airflow and can therefore be easily sucked into the hair container.

FIG. 4 illustrates an enlarged view of a cut-hair-blocking element 18 that has shield members 28a. The embodiment of FIG. 4 is an example of the implementation of a cut-hair-blocking element 18 according to FIG. 2A and therefore not covered by the present invention. However, it will be appreciated that for hair-blocking elements 18 according to FIGS. 2B and 2C a similar configuration might be obtained as shown in FIG. 4. The cut-hair-blocking element 18 may be implemented in the vacuum assisted clipper in FIG. 3A and FIG. 3B. The cut-hair-blocking element 18 may be arranged and positioned for reducing an opening area 34 between the vacuum nozzle 32 and the guard blade 16. In other words, the cut-hair-blocking element 18 may be arranged between the vacuum nozzle 32 and the guard blade 16. The shield members 28a has a comb-like structure. In the example of FIG. 4, the teeth pitch of the comb-like structure may match the guard teeth pitch of the guard blade 16. The guard blade 16 may be a full metal guard of the example vacuum appliance cutter blade in FIG. 3A or the guard blade of the illustrated example in FIG. 3B. In another example (not shown), the teeth slots of the shield members are not aligned with the teeth slots of the guard blade—that is, the teeth pitch of the comb-like structure may be different from the guard teeth pitch of the guard blade. In some examples, the teeth pitch of the shield members may be one-half, one-third, one-fourth or one-fifth of the guard teeth pitch of the guard blade, or the teeth pitch of the comb-like structure may be even smaller. In some other examples, the teeth pitch of the shield members may be twice or more than twice that of the guard blade.

The comb-like structure may allow for a smaller air inlet, which further reduces the opening area 34. The reduction of the opening area 34 at the cutter that the shield members create will generate a higher airspeed at the position, where a high airspeed is required. With the cut-hair-blocking element, the opening area 34 may be four times smaller. Therefore, the air speed may be about three to four times higher and the forces on each hair about nine to sixteen times higher. This makes it more likely to counteract the cutting energy that sprays the hair clippings. Therefore, a higher catching efficiency of the cut hair can be achieved in the hair container. The geometry of the cut-hair-blocking element may be tuned to reduce up to 50% of the opening area between the cutter blade and conventional nozzle, or up to 75% thus tuning the increase in airflow speed at the nozzle.

Additionally, the geometry of the shield members 28a may be tuned in order to tune for both the airflow increase and initial hair length entrance to cutter blade. When specifically focusing on initial hair length entrance in the vacuum nozzle, hair that needs a long length reduction may find the small openings to increase the airspeed too small to reach to the cutter. Due to the short length of the shield teeth in comparison to the long length of the incoming hairs, the latter will not reach the cutter blade as the shield is flattening the hairs, which forces them under the cutter blade. Therefore, the teeth geometry may be tuned to extend their height that allow long incoming hairs to pass through the vacuum nozzle and reach the cutter blade.

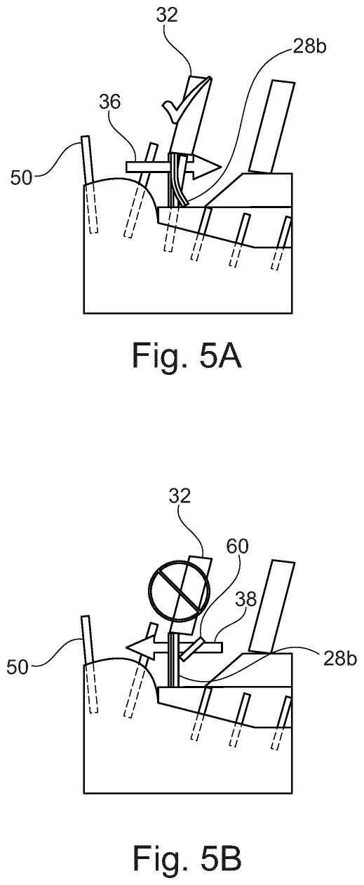

FIGS. 5A and 5B illustrate an example of the cut-hair-blocking element 18 with the barrier members 28b that can be implemented in the vacuum assisted clipper in FIG. 3A and FIG. 3B.

FIG. 5A shows the scenario for allowing hair on skin 50 to enter the cutting zone in a direction indicated by an arrow 36. The barrier function of the barrier members 28b allows hair on skin to pass sufficiently undisturbed through the barrier members 28b. In other words, the barrier members 28b are less stiff than hair on skin 50.

FIG. 5B shows the scenario for preventing hair debris, i.e. cut hair 60, from passing through the barrier members 28b in a direction indicated by an arrow 38. In other words, impact speed and mass of hair debris 60 may be too low to pass through the barrier members 28b. The barrier members 28b are stiff enough to stop hair debris.

That is to say, balancing out the barrier functions mentioned in FIG. 5A and FIG. 5B defines the working window for optimally functioning barrier members. When the barrier members 28b are too stiff, they will disturb or prevent hair on skin from entering the cutting zone. This will affect the hair length which has been cut and the amount of hair which is being cut. On the other hand, when the barrier members are too week, the cut hair, or hair debris, can pass through them. This will increase hair scatter. Therefore, the barrier members 28b may be properly configured to select a material and a geometry to ensure that the barrier members can work within the working window.

The cut-hair-blocking element in the above described embodiments and examples may be retractable such that the cut-hair-blocking element is positionable in an extended position and a retracted position. In the extended position, the cut-hair-blocking element is positioned sufficiently close to the upper side of the cutting arrangement for counter-acting flying off cut hair from the hair-cutting apparatus. In the retracted position, the cut-hair-blocking element is distanced further away from the upper side of the cutting arrangement as compared to the extended position. For example, the cut-hair-blocking element may be positioned to block cut hair from exiting the hair collection system in the process of cutting, whereas the cut-hair-blocking element may be retracted e.g. for the purpose of cleaning the hair-cutting apparatus. Alternatively, the cut-hair-blocking element may be fixed.

The cut-hair-blocking element in the above described embodiments and examples may be integrated to the nozzle design of the appliance without requires an additional component. An example of the integrated cut-hair-blocking element is shown in FIGS. 5A and 5B, where the barrier members are arranged along an outer side of the vacuum nozzle. Alternatively, the cut-hair-blocking element in the above described embodiments and examples may be a separate component that is placed between the cutter of the cutter blade and the vacuum nozzle. For example, the cut-hair-blocking element 18 as shown in FIG. 4 creates a fine teeth pitch primary shield. Cut hairs shooting away from the hair collection vacuum nozzle are blocked by the primary hair spray shield, thus preventing them from exiting the hair collection system and falling on the surrounding environment.

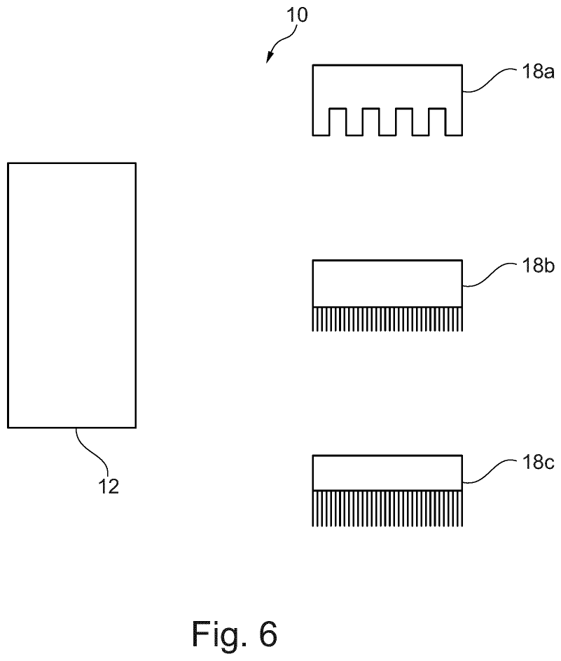

FIG. 6 illustrates another exemplary implementation of the hair-cutting apparatus 10, also referred to as hair-cutting apparatus kit. The hair-cutting apparatus 10 comprises a series of detachable cut-hair-blocking elements 18, such as 18a, 18b, 18c in FIG. 6, besides the cutting arrangement 12. The detachable cut-hair-blocking elements 18 may have different types of cut-hair-blocking members. For example, the cut-hair-blocking element 18a has shield members. Blocking element 18a is outside the scope of the present invention. The cut-hair-blocking element 18b and 18c have barrier members. The series of detachable cut-hair-blocking elements 18a, 18b, 18c comprises at least a first detachable cut-hair-blocking element, such as 18a, and a second detachable cut-hair-blocking element, such as 18b. The first detachable cut-hair-blocking element 18a has a hair receiving portion that allows hair to be cut with a first length to pass through hair receiving portion to enter a cutting zone. The second detachable cut-hair-blocking element 18b has a hair receiving portion that allows hair to be cut with a second length to pass through hair receiving portion to enter the cutting zone. The first length is different from the second length. For example, the shield members of the detachable cut-hair-blocking element 18a are configured such that the interspace between adjacent shield members has a geometry that is adapted to a desired haircut length including at least one of the first length and the second length. For example, the barrier members of the detachable cut-hair-blocking elements 18b and/or 18c are configured to have a height that is adapted to a desired haircut length including at least one of the first length and the second length.

An advantage of having the example hair-cutting apparatus kit in FIG. 6 may be seen in that the geometry of each cut-hair-blocking element may be tuned in order to tune for both the airflow increase and initial hair length entrance to the cutter blade.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A hair-cutting apparatus, comprising:
a cutting arrangement for cutting hair; and
a cut-hair-blocking element arranged in front of a cutting zone of the cutting arrangement in a direction in which the hair-cutting apparatus is moved to cut hairs during use, and sufficiently close to an upper side of the cutting arrangement for counter-acting flying off cut hair from the hair-cutting apparatus, wherein the upper side is opposite to a skin-touching side of the cutting arrangement;
wherein the cut-hair-blocking element has a hair receiving portion at a bottom of the cut-hair-blocking element close to the cutting zone for allowing hair to be cut to pass through the hair receiving portion to enter the cutting zone;
wherein the hair receiving portion has a row of cut-hair-blocking members, wherein
adjacent cut-hair-blocking members have an interspace therebetween that is sufficiently small to prevent the cut hair from passing through the interspace, or
adjacent cut-hair-blocking members have no interspace therebetween;
wherein the cut-hair-blocking members comprise barrier members;
wherein the barrier members are sufficiently flexible such that the barrier members undergo sufficiently large deformation under a force caused by the hair to be cut for allowing the hair to be cut to pass through the barrier members to enter the cutting zone; and
wherein the barrier members are sufficiently stiff such that the barrier members undergo no or little deformation under a force caused by the cut hair for preventing the cut hair from flying off; and
wherein the cut-hair-blocking members are contiguous to a tip of a guard blade of the cutting arrangement.

2. The hair-cutting apparatus according to claim 1, wherein
the cut-hair-blocking members further comprise shield members;
the shield members are sufficiently stiff such that the shield members undergo no or little deformation under a force caused by the hair to be cut and under a force caused by the cut hair for preventing the cut hair from flying off;
the interspace between adjacent shield members is sufficiently large to allow the hair to be cut to pass through the interspace to enter the cutting zone; and
the barrier members are arranged within the interspace between the adjacent shield members.

3. The hair-cutting apparatus according to claim 1, further comprising:
a vacuum nozzle for transporting the cut hair to a hair chamber;
wherein the cut-hair-blocking element is arranged and positioned for reducing an opening area between the vacuum nozzle and the cutting arrangement.

4. The hair-cutting apparatus according to claim 2,
wherein the shield members are provided in the form of a comb-like structure.

5. The hair-cutting apparatus according to claim 1,
wherein the barrier members are provided in the form of a brush-like structure and/or a strip-curtain-like structure.

6. The hair-cutting apparatus according to claim 1,
wherein the cut-hair-blocking element has a boundary wall for counter-acting the flying off cut hair from the hair-cutting apparatus.

7. The hair-cutting apparatus according to claim 2,
wherein the shield members have a pitch that matches a pitch of the guard blade.

8. The hair-cutting apparatus according to claim 1, wherein
the cut-hair-blocking element is retractable such that the cut-hair-blocking element is positionable in an extended position and a retracted position;
in the extended position, the cut-hair-blocking element is positioned sufficiently close to the upper side of the cutting arrangement for counter-acting the flying off cut hair from the hair-cutting apparatus; and
in the retracted position, the cut-hair-blocking element is distanced further away from the upper side of the cutting arrangement as compared to the extended position.

9. The hair-cutting apparatus according to claim 1,
wherein the cut-hair-blocking element is an element integrated with the hair-cutting apparatus.

10. The hair-cutting apparatus according to claim 1,
wherein the cut-hair-blocking element is a detachable element.

11. The hair-cutting apparatus according to claim 10, further comprising:
a series of detachable cut-hair-blocking elements;
wherein the series of detachable cut-hair-blocking elements comprises at least a first detachable cut-hair-blocking element and a second detachable cut-hair-blocking element;
wherein the first detachable cut-hair-blocking element has a first hair receiving portion that allows the hair to be cut with a first length to pass through the hair receiving portion to enter the cutting zone;
wherein the second detachable cut-hair-blocking element has a second hair receiving portion that allows the hair to be cut with a second length to pass through the hair receiving portion to enter the cutting zone; and
wherein the first length is different from the second length.

12. The hair-cutting apparatus according to claim 2, further comprising a series of detachable cut-hair-blocking elements;
wherein the series of detachable cut-hair-blocking elements comprises at least a first detachable cut-hair-blocking element and a second detachable cut-hair-blocking element;
wherein the first detachable cut-hair-blocking element has a first hair receiving portion that allows the hair to be cut with a first length to pass through the hair receiving portion to enter the cutting zone;
wherein the second detachable cut-hair-blocking element has a second hair receiving portion that allows the hair to be cut with a second length to pass through the hair receiving portion to enter the cutting zone;
wherein the first length is different from the second length; and
wherein the shield members are configured such that the interspace between the adjacent shield members has a geometry that is adapted to a desired haircut length including at least one of the first length and the second length.

13. The hair-cutting apparatus according to claim 11,
wherein the barrier members are configured to have a height that is adapted to a desired haircut length including at least one of the first length and the second length.
